(19) United States
(12) Patent Application Publication
(10) Pub. No.: US 2024/0352313 A1
(43) Pub. Date: Oct. 24, 2024

(54) QUANTUM EMITTERS AND METHODS THEREOF

(71) Applicant: University of Maryland, College Park, College Park, MD (US)

(72) Inventors: YuHuang Wang, Laurel, MD (US); Haoran Qu, Santa Clara, CA (US); Xiaojian Wu, Round Lake, IL (US); Jacob Fortner, College Park, MD (US)

(21) Appl. No.: 18/643,736

(22) Filed: Apr. 23, 2024

Related U.S. Application Data
(60) Provisional application No. 63/497,996, filed on Apr. 24, 2023.

(51) Int. Cl. C09K 11/65; C01B 32/159; C01B 32/168; C09K 11/02

(52) U.S. Cl. CPC C09K 11/65; C01B 32/159; C01B 32/168; C09K 11/02; C01B 2202/02; C01P 2004/13; C01P 2004/64; C01P 2006/60

(57) ABSTRACT

This present disclosure is directed to functionalized single-walled carbon nanotubes, quantum emitter compositions comprising functionalized single-walled carbon nanotubes, and methods of making the same. The nanotubes and emitters disclosed herein provide higher degrees of selectivity of emission properties.

### CROSS REFERENCE TO RELATED APPLICATIONS

This application claims priority to U.S. Application No. 63/497,996, filed on Apr. 24, 2023 the contents of which are hereby incorporated by reference in its entirety.

### STATEMENT OF FEDERALLY SPONSORED RESEARCH AND DEVELOPMENT

This invention was made with government support under CHE2204202 awarded by the National Science Foundation. The government has certain rights in the invention.

### FIELD OF THE INVENTION

The field of the invention relates generally to single-walled carbon nanotubes, monodispersed quantum emitters, and more particularly to functionalized single-walled carbon nanotubes and methods of preparation thereof.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Organic color centers (OCCs) are molecularly tunable quantum defects that can be synthesized by covalently attaching functional groups to the single-walled carbon nanotubes (SWCNT) sidewall. The defects display a number of intriguing properties, including new optically-allowed states (E₁₁_{^{−}} and E₁₁_{^{−}}*) that are redshifted from the SWCNT band-edge emission (E₁₁) in the shortwave infrared, brightening dark excitons, ultrafast trapping of excitons, stabilization of trions, and the emission of single photons at room temperature. However, the majority of synthetic chemistry for OCCs (e.g., diazonium chemistry, diazoether chemistry, reductive alkylation, and photoactivated radical addition) are monovalent-based, which produce a large numbers of different bonding configurations on the same nanotube structure. This structural heterogeneity is in part due to the addition reaction to the nanotube double bond, which produces an unpaired electron that typically bonds with a H or OH group available in solution to close the valence state, with the reaction occurring at any one of the six neighboring carbon atoms relative to the initial functional group (FIG. 1a). This structural heterogeneity has posed a synthetic challenge for the rapidly emerging applications of OCCs in chemical sensing, and bioimaging, disease diagnostics, single photon sources.

One possible solution to this heterogeneity problem is the use of divalent functional groups for OCCs, in which the two bonds are created equally. However, currently available divalent OCCs (e.g., those functionalized by 1,2-diiodobenezene) are produced as a mixture of both monovalent and divalent OCCs presumably due to the step-wise nature of the addition reaction. Alternative divalent chemistry is cycloaddition, in which the two bonds are created simultaneously and the divalent functional group provides its own pairing bond, which may help decrease the structural heterogeneity caused by the bonding of a different functional group, H or OH. One such cycloaddition chemistry is the Diels-Alder reaction, which typically features [4+2] cycloaddition between a diene and dienophile. Star et al. have shown the reaction is preferentially proceed via a [2+2] pathway for the cycloaddition of enones to SWCNTs. Conceptually, a [2+2] cycloaddition reaction on SWCNTs would reduce the number of possible OCC bonding configurations to just three (3)—a substantial reduction compared to the six (6) bonding configurations of monovalent OCCs (FIG. 1).

### DESCRIPTION

Herein is disclosed is novel functionalized single-walled carbon nanotubes and methods thereof.

One aspect of the invention pertains to a functionalized single-walled carbon nanotube, said nanotube comprising at least one divalent functional group of Formula I:

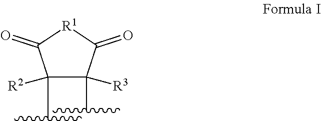

wherein R¹ is chosen from —O—, —NR⁴, and —CR⁵R⁶;
R² and R³ are independently chosen from H and —C₁₋₄ alkyl;
R⁴ is H or —C₁₋₄ alkyl;
R⁵ is H or C₁₋₆ alkyl;
R⁶ is H or C₁₋₆ alkyl; and
wherein said at least one divalent functional group is covalently bonded to a sidewall of said single-walled carbon nanotube; and
wherein said nanotube emits near infrared photons at a wavelength in the range of about 900 nm to about 1700 nm.

In some embodiments, said functionalized single-walled carbon nanotubes disclosed herein have three (3) bonding configurations. In further embodiments, said functionalized single-walled carbon nanotubes disclosed herein have a dominant single bonding configuration capable of emitting single photons at about 1112, about 1139 or about 1213 nm wavelength. In yet further embodiments, said functionalized single-walled carbon nanotubes disclosed herein have dominant single bonding configuration capable of emitting single photons at about 1112, about 1139 or about 1213 nm wavelength.

Another aspect of the invention pertains to a functionalized single-walled carbon nanotube, wherein said nanotube is made by a process comprising the steps of:
a. combining single-walled carbon nanotubes with a solvent having a boiling point higher than 110° C. to form a suspension;
b. adding one or more compounds of Formula IIIB to said suspension to form a mixture comprising a liquid component and a solid component;
c. increasing the temperature of said mixture to the range of about 90° C. to about 140° C. for a period of time; and
d. filtering said mixture to obtain the solid components.
   wherein said nanotube emits photons at a wavelength between 900 nm and 1700 nm.

A further aspect of the invention pertains to a method of making a functionalized single-walled carbon nanotube, said method comprising:
a. combining single-walled carbon nanotubes with a solvent having a boiling point higher than 110° C. to form a suspension;
b. adding a compound of Formula III to said suspension to form a mixture comprising a liquid component and a solid component;

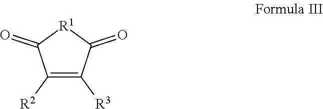

wherein R¹ is chosen from —O—, —NR₄, and —CR₅R₆;
   R² and R³ are independently chosen from H and —C₁₋₄ alkyl;
   R⁴ is H or —C₁₋₄ alkyl;
   R⁵ is H or —C₁₋₆ alkyl; and
   R⁶ is H or —C₁₋₆ alkyl;
c. increasing the temperature of said mixture for a period of time; and
d. after said period of time, separating said solid components from said liquid components.

Embodiments of the present disclosure include a novel room-temperature monodispersed quantum emitter composition comprising a functionalized single-walled carbon nanotube disclosed herein. These compositions may be used in applications such as cancer diagnostics, chemical sensing devices, bioimaging devices and for personal health care devices such as glucose monitoring, quantum computing and telecom circuitry. Advantages of the functionalized single-walled carbon nanotubes disclosed herein (and compositions comprising said nanotubes) include: (i) single photons in the shortwave infrared (˜900-1700 nm), covering both near-infrared bioimaging windows and the telecom wavelengths-lowering the barrier for integration with existing telecom technologies; (ii) high purity, brightness, indistinguishable single photons; (iii) room temperature operation; (iv) on-demand-electrically or optically triggered monodisperse single photons; and (iv) high repetition and stability.

Moreover, divalent OCC emissions can be improved by modifying said nanotubes disclosed herein with pre-treatment and/or post-treatment of the nanotubes as described in the dissertation publication by Haoran Qu entitled, “Fluorescent Carbon Nanotubes as Molecular Sensors and Color-Center Hosts” (May 2022), which is incorporated by reference in its entirety.

### BRIEF DESCRIPTION OF THE FIGURES

The following drawings form part of the present specification and are included to further

demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIGS. 1A-1B. FIG. 1 displays a schematic comparing monovalent vs. [2+2] cycloaddition divalent OCCs and the resulting bonding configurations. In FIG. 1A, monovalent chemistry using diazonium salt to functionalize SWCNTs is displayed. Six possible bonding configurations of the resulting OCCs are generated via an addition reaction on the sp² carbon lattice. The gray atom at the center shows the aryl group attachment site, while the pairing group (either H or OH) may add to the other 6 atoms shown in cyan. FIG. 1B displays that divalent chemistry via [2+2] cycloaddition can be used to functionalize SWCNTs with enophile molecules, including N-MMI, MA, or CPD in ethylene glycol at elevated temperature, producing 3 possible bonding configurations (shown in cyan atoms).

FIGS. 2A-2E. FIG. 2 displays OCC generation on SWCNTs via cycloaddition using N-MMI. FIG. 2A displays a PL excitation map of the pristine SWCNT starting material, which primarily features the (6, 5) nanotube chirality, but also a mixture of other chiralities, including (8, 3), (7, 5), (8, 4), and (9, 2). FIG. 2B displays the PL excitation-emission map of the nanotubes from FIG. 2A after reacting with N-MMI at a [N-MMI]: [C] ratio of 7:1 at 100° C., showing

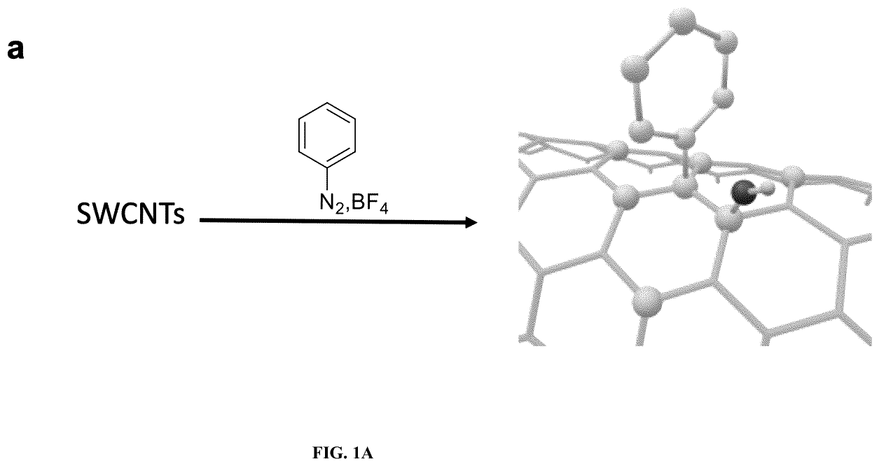

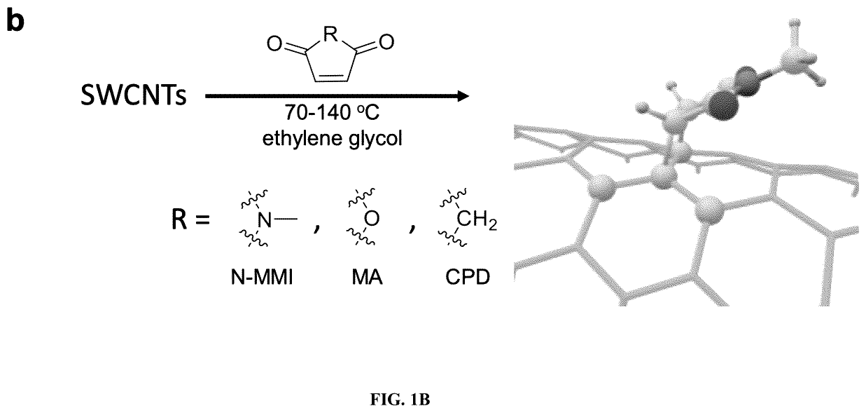

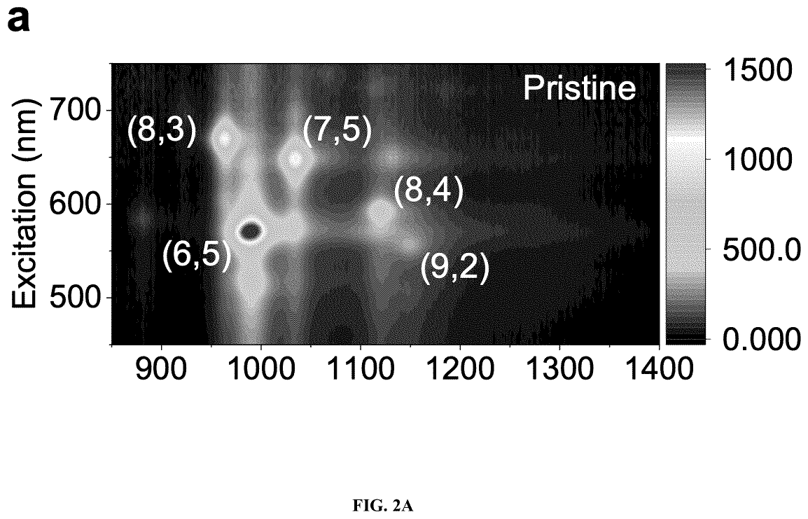

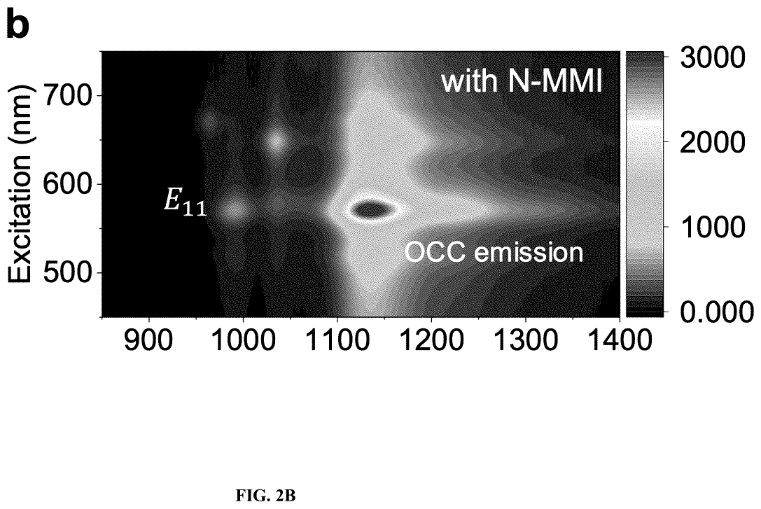

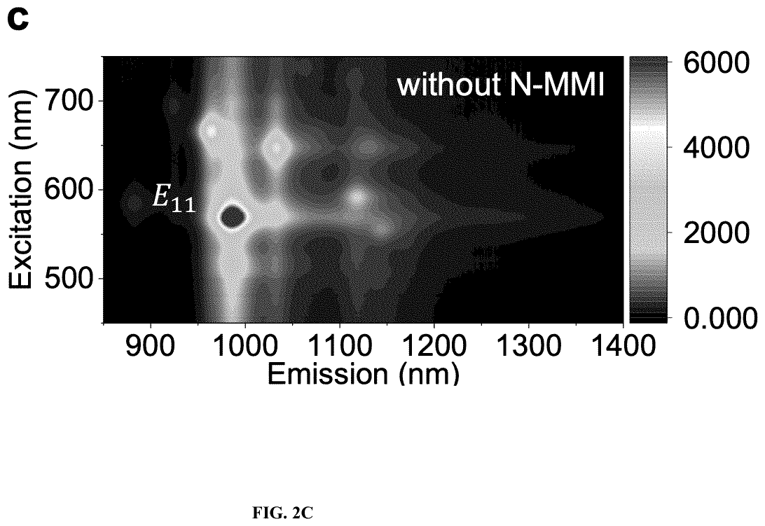

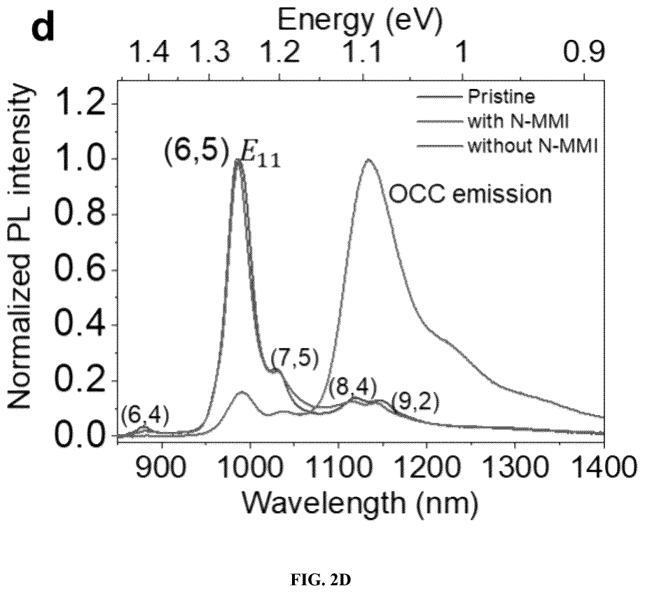

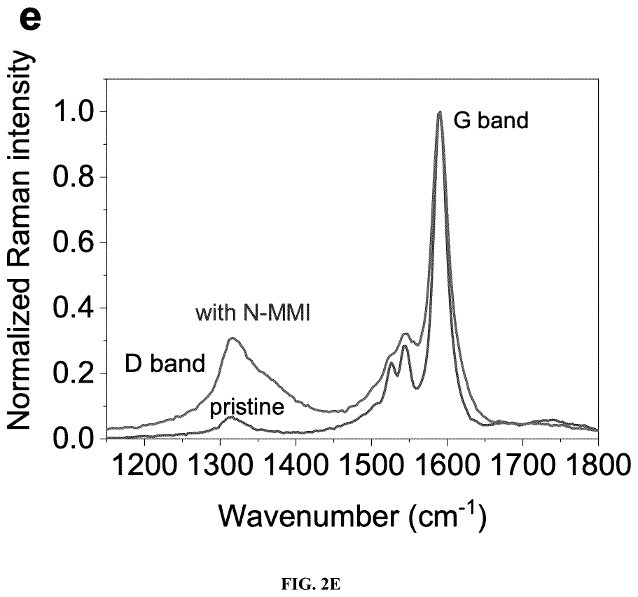

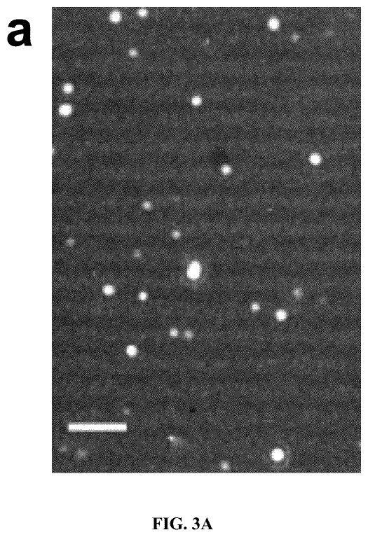

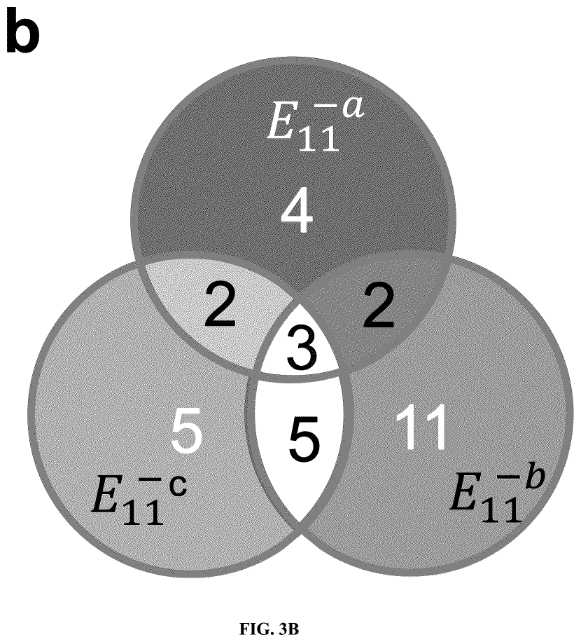

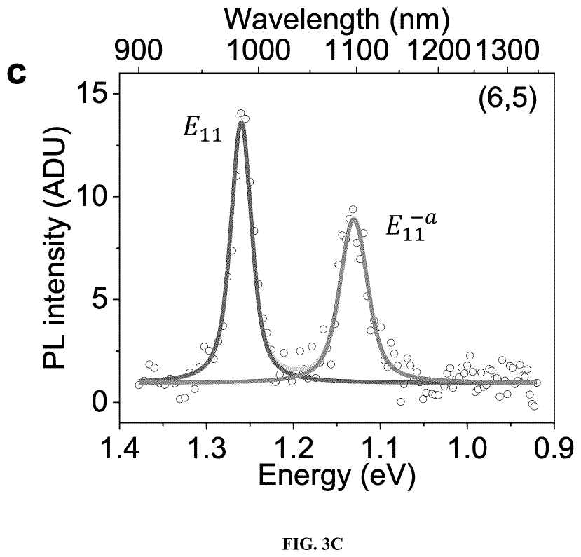

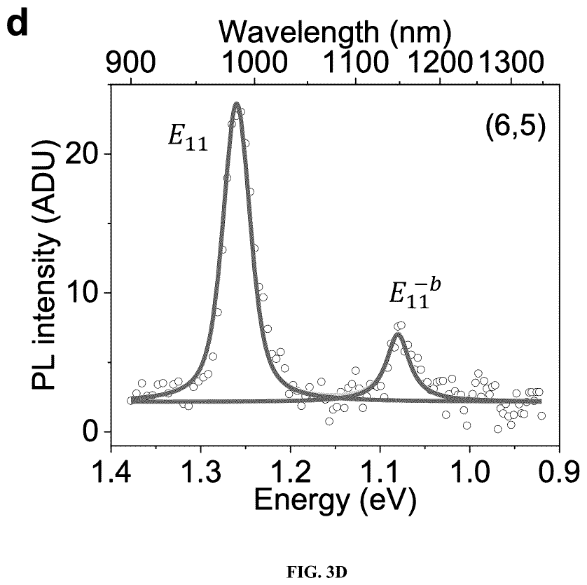

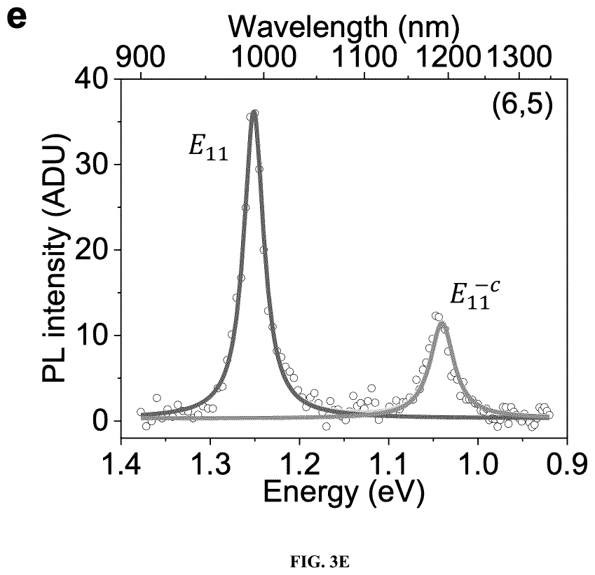

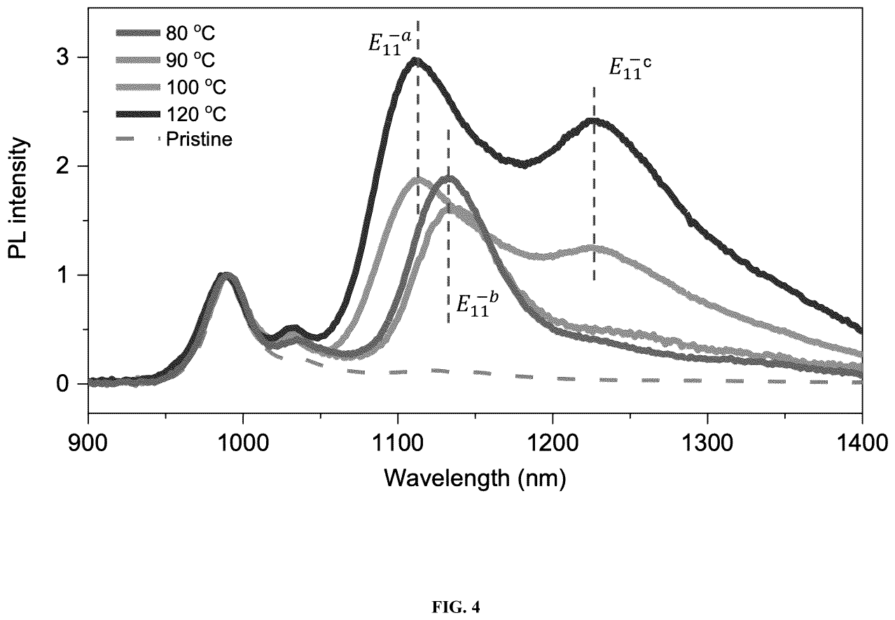

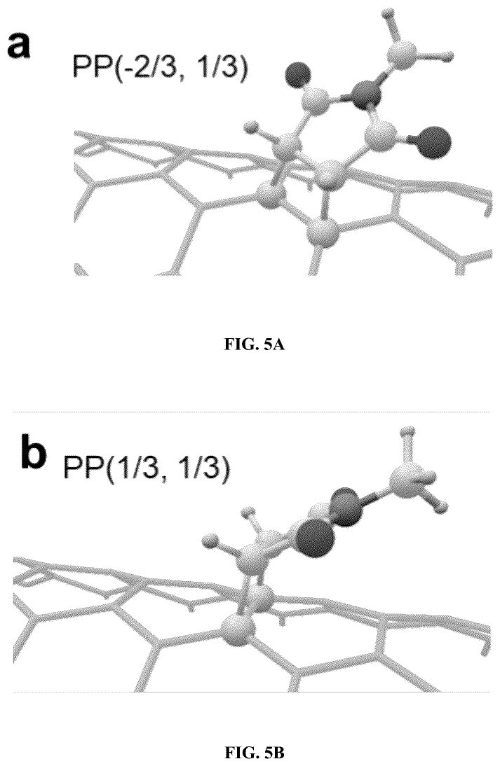

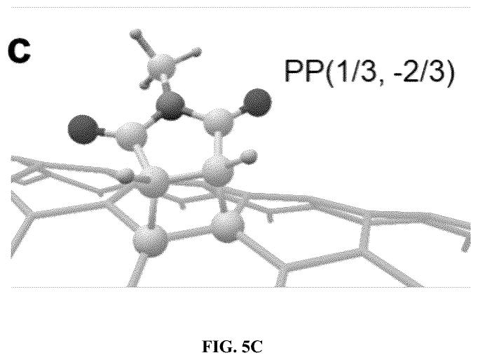

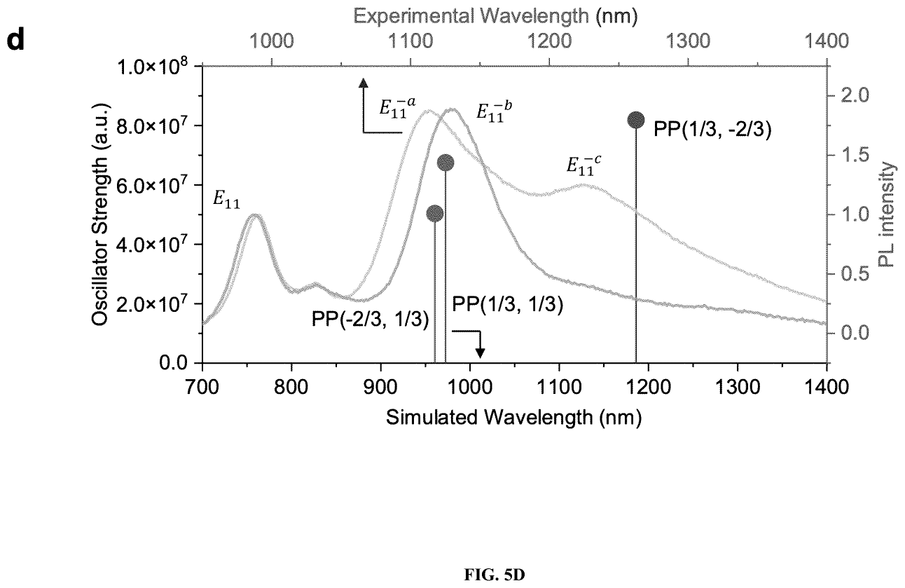

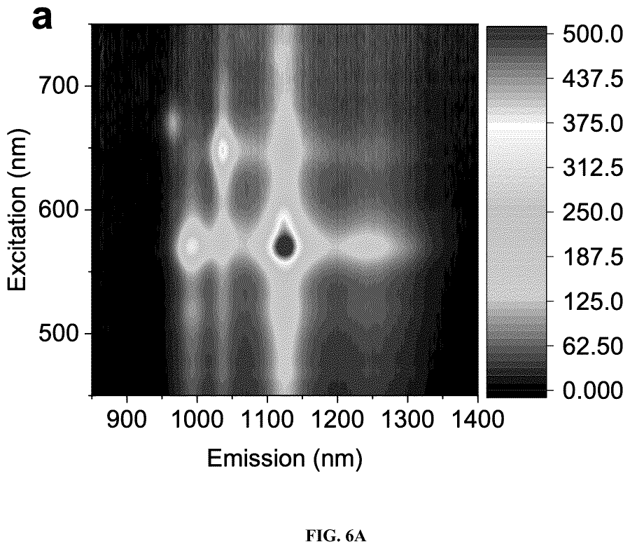

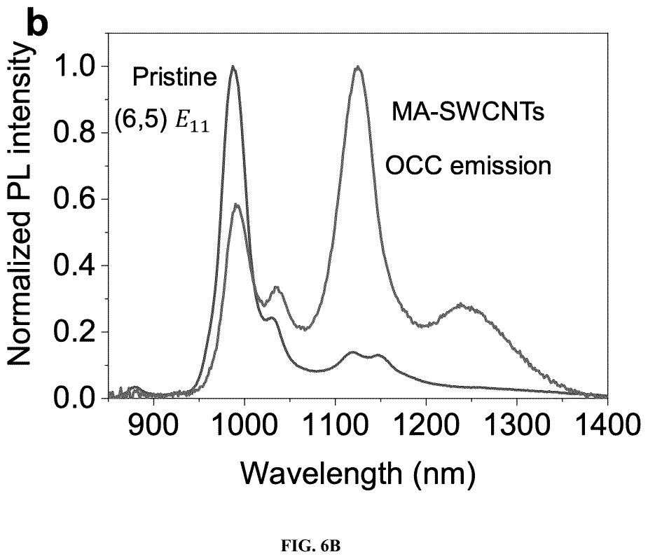

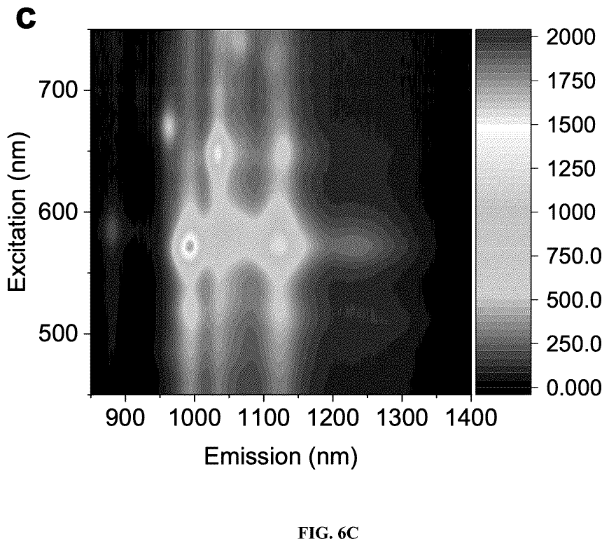

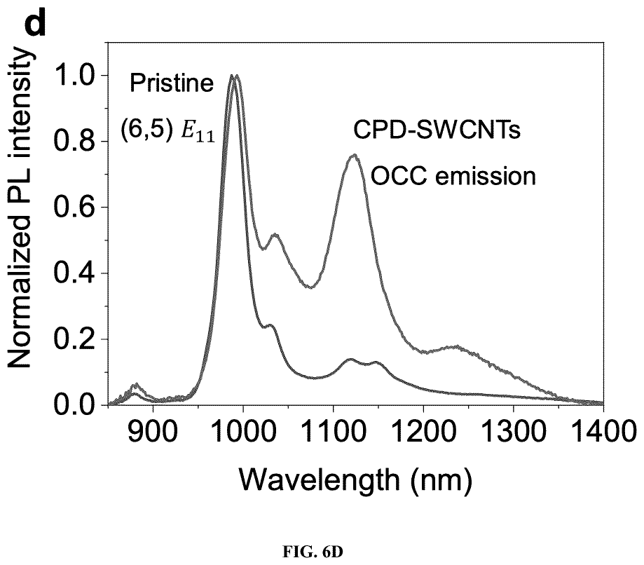

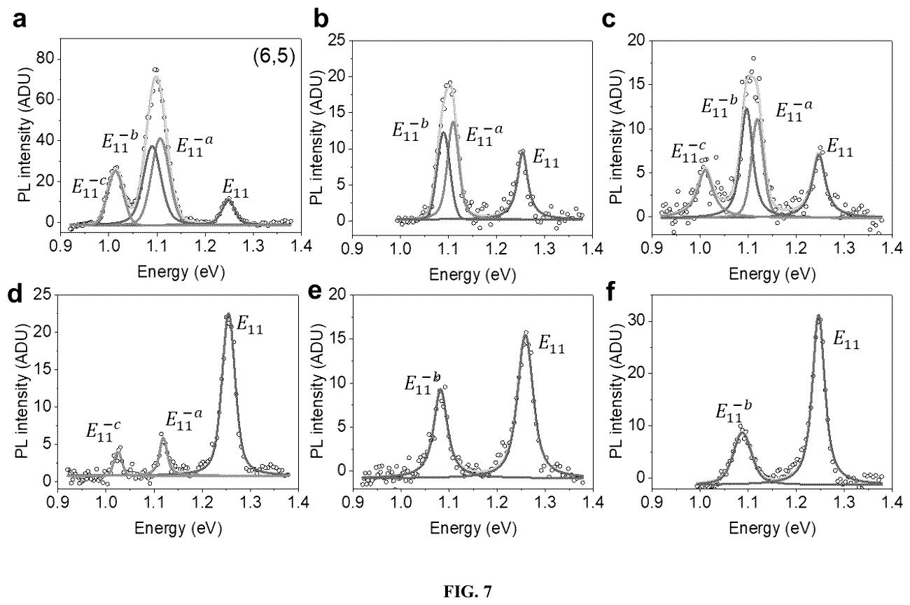

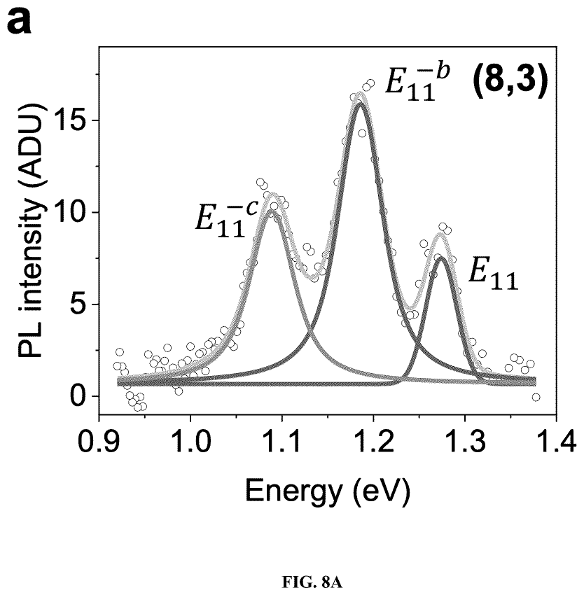

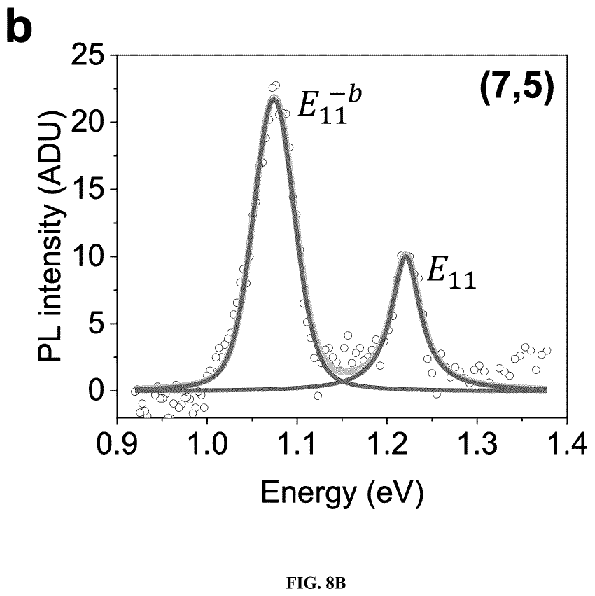

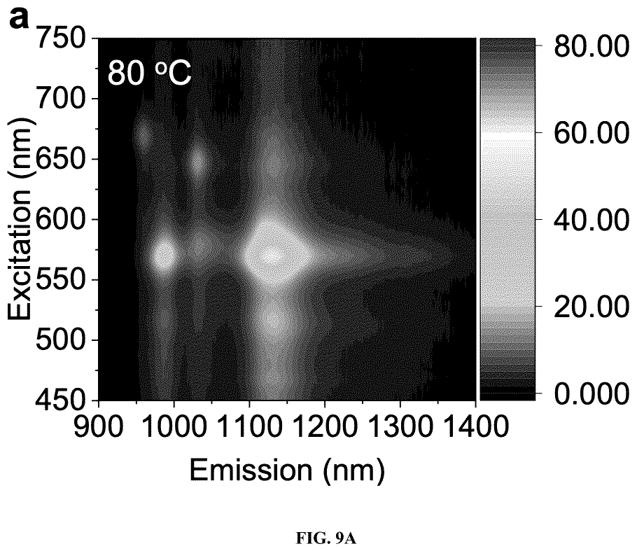

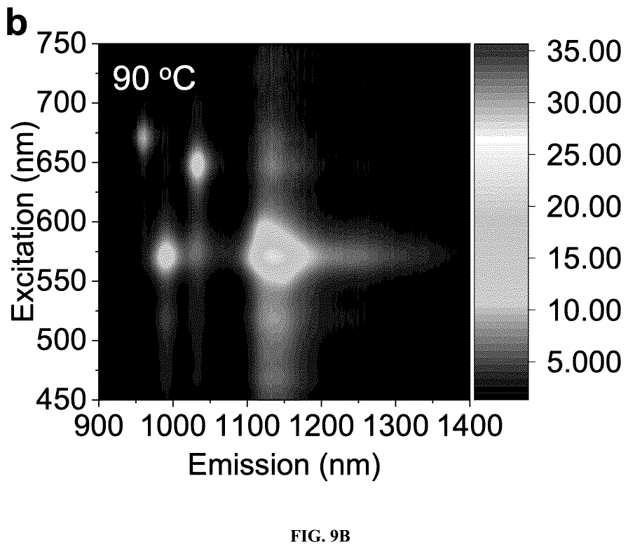

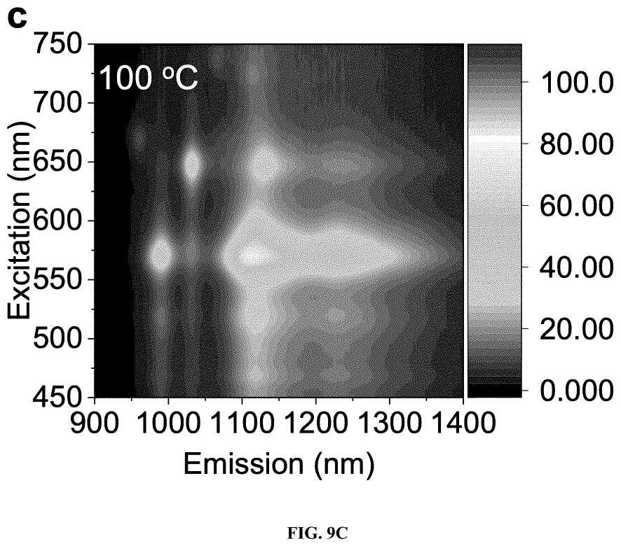

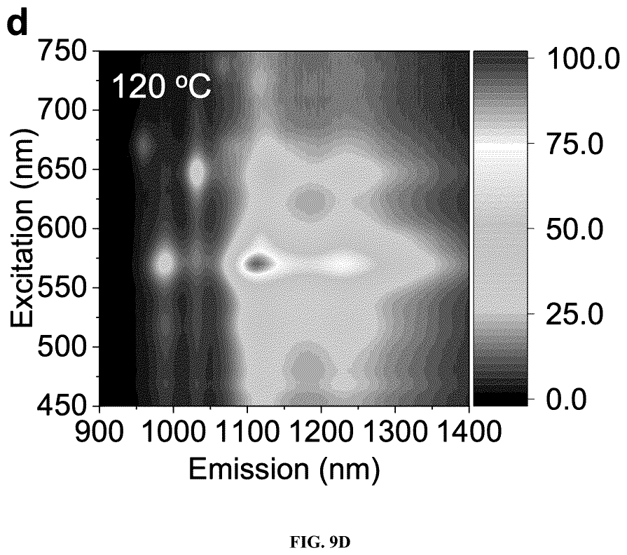

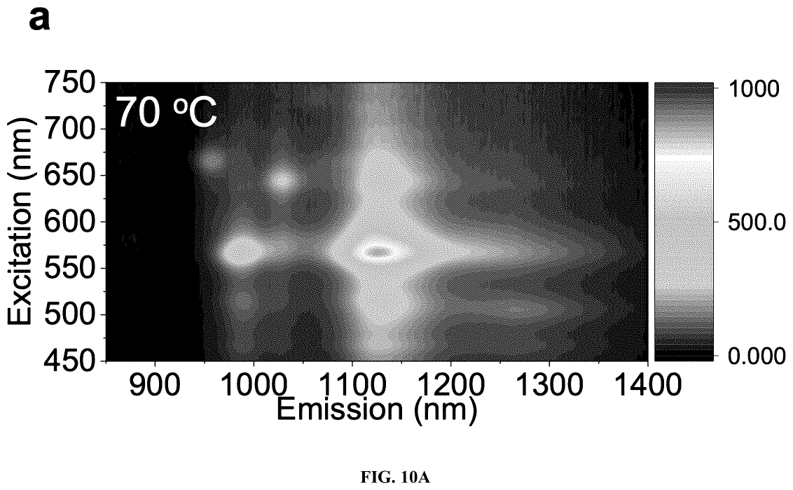

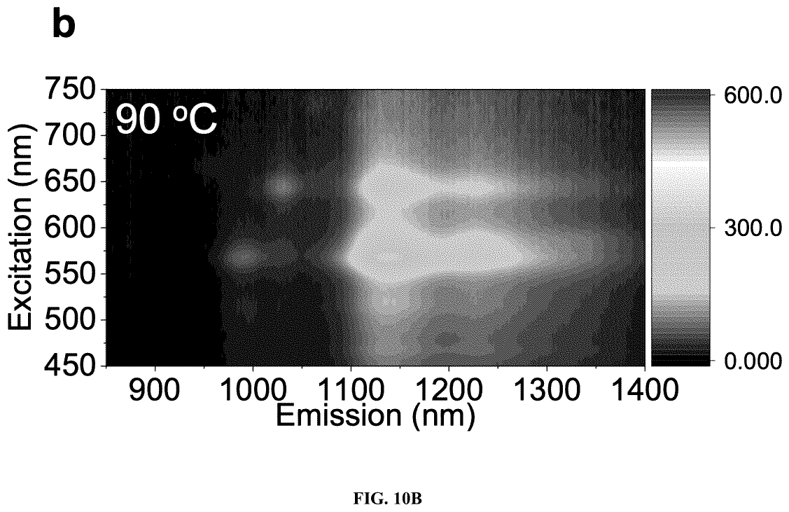

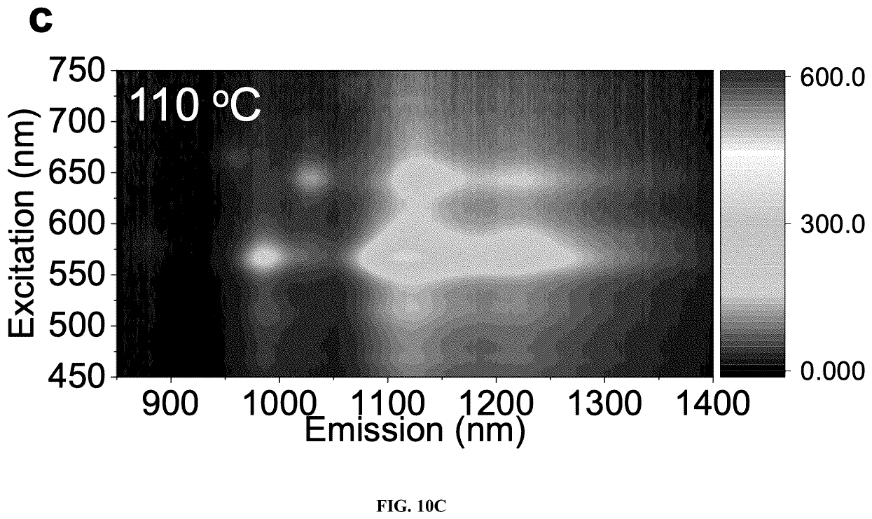

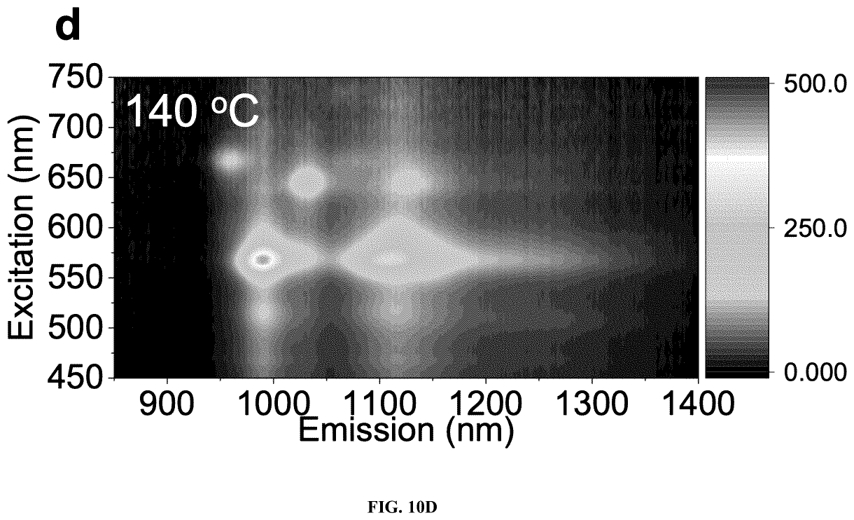

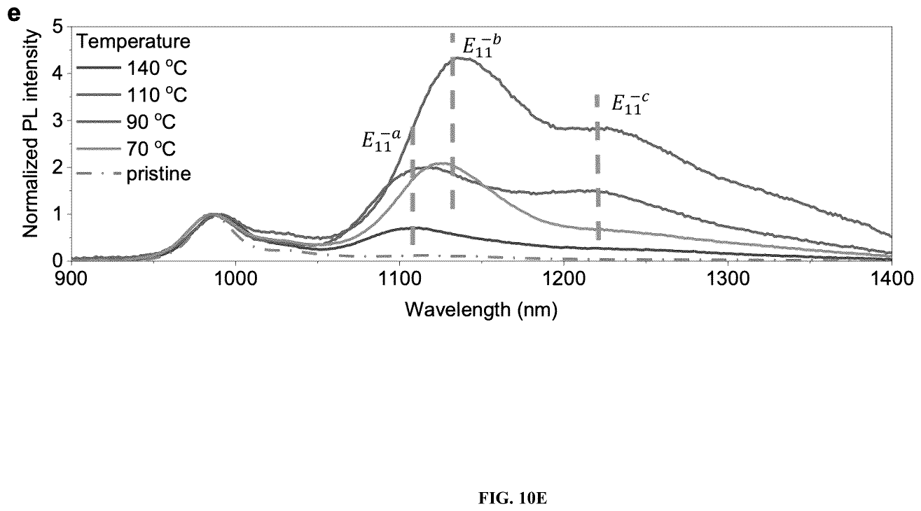

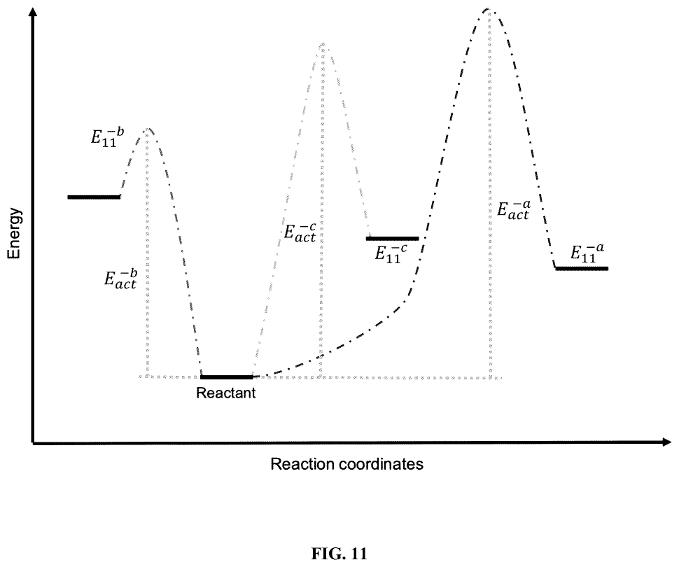

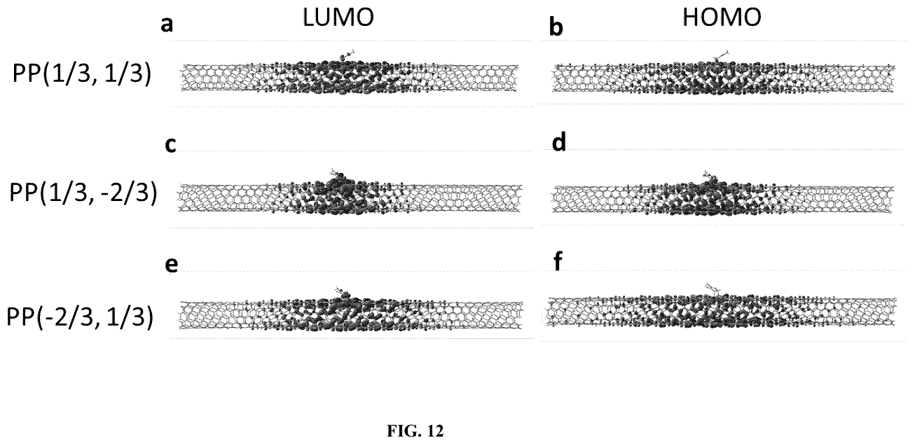

OCC emission at wavelengths in the range of 1100-1300 nm. FIG. 2C displays the PL excitation map of the SWCNTs from FIG. 2A treated under the same conditions as in FIG. 2B at 100° C., but without the addition of N-MMI. FIG. 2D displays a PL spectra of the pristine (6,5)-SWCNT starting material (black), after reaction with N-MMI (red), and after treatment to the same reaction conditions but without the addition of N-MMI (blue). The SWCNTs are excited at their E22 transition (565 nm). All the PL spectra were measured after dispersing the samples in 1 wt % DOC/D20. Note the small peaks in the starting material and control group emitting at ˜880 nm, ˜1030 nm, ˜1118 nm, and ˜1148 nm are the E₁₁ emissions from pristine (6,4), (7,5), (8,4) and (9,2)-SWCNTs, respectively. FIG. 2E displays Raman spectra of SWCNTs reacted with N-MMI (red) and the pristine SWCNT starting material (black). Note the PL spectra are normalized to the maximum peak intensity, and the Raman spectra are normalized to the G-band at ˜1580 cm⁻¹

FIGS. 3A-3E. FIG. 3 displays Hyperspectral PL imaging of individual N-MMI-(6,5)-SWCNTs. In FIG. 3A, a hyperspectral image of the N-MMI-SWCNTs is displayed. FIG. 3B displays a Venn diagram illustrating the statistically analyzed OCC functionalization emissions of the 32 measured individual nanotubes synthesized at 100° C. Three sets of nanotubes are found: nanotubes containing E₁₁_{^{−a}} only (blue), nanotubes containing E₁₁_{^{−b}}, only (red), and nanotubes containing E₁₁_{^{−c}} only (green). The overlap between circles represents nanotubes containing two or more OCC emission peaks. The numbers indicate the number of nanotubes containing one or more specific OCC peaks. FIGS. 3C-E display PL spectra of individual N-MMI-(6,5)-SWCNTs with different OCC emission peaks of E₁₁_{^{−b}} (FIG. 3C), E₁₁_{^{−b}} (FIG. 3D), and E₁₁_{^{−c}} (FIG. 3E).

FIG. 4. FIG. 4 displays temperature-dependent OCC emissions from the reaction of (6,5)-SWCNTs with N-MMI at [N-MMI]:[C]=7:1. FIG. 4 also displays PL spectra of (6,5)-SWCNTs reacted at 80° C. (blue), 90° C. (green), 100° C. (orange), and 120° C. (red). The PL spectrum of the pristine SWCNTs is shown by the dashed gray line. The PL spectra are normalized to the E₁₁ emission of the (6,5)-SWCNTs.

FIGS. 5A-5D. FIG. 5 displays the emission and relative energy of the 3 possible bonding configurations of OCCs generated by N-MMI. FIGS. 5A-5C display schematics of the OCC bonding configurations formed on the SWCNT based on the [2+2] cycloaddition reaction, in which the functional group is covalently bonded at a pair of nanotube carbon atoms indicated by PP (−⅔, ⅓) (33° to the SWCNT axis) (FIG. 5A), PP (⅓, ⅓) (87° to the SWCNT axis) (FIG. 5B), and PP (⅓,−⅔) (27° to the SWCNT axis) (FIG. 5C). FIG. 5D displays TD-DFT simulated emission wavelengths of OCCs featuring the PP (—⅔, ⅓) (red), PP (1/3, 1/3) (blue) and PP (⅓, −½) (black) bonding configurations (oscillator strength vs. simulated wavelength shown in the left and bottom axes in black), superimposed with the experimental PL spectra from N-MMI-(6,5)-SWCNTs at 80° C. (green) and 100 C (yellow) (PL intensity vs. experimental wavelength shown in the right and top axes in red).

FIGS. 6A-6D. FIG. 6 display s OCC generation with MA and CPD. FIG. 6A displays a PL excitation-emission map of SWCNTs reacted with MA. FIG. 6B displays a PL spectra of the pristine (black) and MA-SWCNTs excited at 565 nm. FIG. 6C displays a PL excitation-emission map of SWCNTs reacted with CPD. FIG. 6D displays PL spectra of the pristine (black) and CPD-SWCNTs excited at 565 nm. Note the PL spectra are normalized to the maximum intensity.

FIG. 7. FIG. 7 displays PL spectra of individual (6,5)-SWCNTs. The OCC emissions are color-coded: E₁₁ (red), E₁₁_{^{−}} (purple), E₁₁_{^{−}} (blue), and E₁₁_{^{−}}* (green).

FIGS. 8A-8B. FIG. 8 displays the OCC emissions of N-MMI-(8,3,)-SWCNTs (FIG. 8A), and N-MMI-(7,5)-SWCNTs (FIG. 8B).

FIGS. 9A-9D. FIG. 9 displays temperature-dependent OCC emissions from the reaction of (6,5)-SWCNTs with N-MMI. PL excitation-emission maps of SWCNTs reacted with N-MMI at [N-MMI]: [C]=7:1 and 80° C. (FIG. 9A), 90° C. (FIG. 9B), 100° C. (FIG. 9C), and 120° C. (FIG. 9D).

FIGS. 10A-10E. FIG. 10 displays temperature-dependent OCC emissions from the reaction with MA. PL excitation-emission maps of SWCNTs reacted with [MA] at [MA]: [C]=20:1 and 70° C. (FIG. 10A), 90° C. (FIG. 10B), 110° C. (FIG. 10C), and 140° C. (FIG. 10D). FIG. 10E displays PL spectra of (6,5)-SWCNTs reacted at 70° C. (green), 90° C. (blue), 110° C. (red), and 140° C. (purple). The PL spectra are normalized to the E₁₁ emission of the (6,5)-SWCNTs. Note that the E₁₁ wavelength of these 4 samples slightly vary (by 6 nm) due to water filling or ethylene glycol filling of the nanotubes, causing the E₁₁_{^{−a}}, E₁₁_{^{−b}} and E₁₁_{^{−c}}OCC emissions to vary as well.

FIG. 11. FIG. 11 displays a schematic of the reaction coordinates. The activation energy of the 3 pathways for synthesizing the bonding configurations that emit at E₁₁_{^{−}}, E₁₁_{^{−}}* and E₁₁_{^{−}} are E_{act}_{^{−a}}, E_{act}_{^{−b}}, and E_{act}_{^{−c}}38 , respectively. Note that the relative energy between the reactant and each product was determined by DFT.

FIG. 12. FIG. 12 displays images depicting the natural transition orbitals (NTO) of OCCs with different bonding configurations. FIGS. 12A and 12B displays the LUMO and HOMO of PP (1/3, 1/3), respectively. FIGS. 12C and 12D display the LUMO and HOMO of PP (⅓,−⅔), respectively. FIGS. 12D and 12E display the LUMO and HOMO of PP (−⅔, ⅓), respectively. Note that only the NTO pairs that dominantly contribute to the transition (>60%) were included in the plots.

Particular non-limiting embodiments of the present invention will now be described with reference to accompanying drawings.

### DEFINITIONS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a +10% variation from the nominal value. It is

to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “photoluminescence,” abbreviated as “PL”, as used herein, refers to any process by which an incoming photon excites an electron to a higher energy level, and an outgoing photon is then given off or emitted upon the relaxation of said electron. The wavelengths of the emissions of the outgoing photon can be measured by standard techniques known in the art, such as photoluminescent spectroscopy, Raman spectroscopy, fluorescence microscopy, fluorimetry, infrared spectroscopy or other similar techniques. Relatedly, the term “electroluminescence” as used herein refers to any process by which the application of an electric current, an electric field, or controlled injection of electrons and holes causes the excitation of an electron to a higher energy level, which emits a photon upon relaxation.

The term “quantum emitter” as used herein, refers to a material which may emit single photons.

The term “functionalized single-walled carbon nanotube” as used herein, refers to hexagonally oriented carbon atoms (graphene) arranged in a circular tube-like shape with a diameter in the range of about 0.5 nm to about 2.0 nm, which are not nested in other nanotubes or contain other nested nanotubes, and which contain a number of functional group protruding externally from the sidewall of said nanotubes.

The term “monodispersed” as used herein, refers to a quantum emitter composition which is uniformly or singularly dispersed in terms of the distribution of functional groups and the relative configurations of said functional groups.

The term “sidewall” as used herein, refers to the external surface of the carbon nanotube. Only one sidewall exists with a single-walled carbon nanotube.

The term “CPD”, as used herein, refers to 4-cyclopentene-1,3-dione.

The term “MA”, as used herein, refers to maleic anhydride.

The term “N-MMI”, as used herein, refers to methylmaleimide

The term “HOMO”, as used herein, refers to the highest occupied molecular orbital within molecular orbital theory, and represents the lower boundary of the HOMO-LUMO gap.

The term “LUMO”, as used herein, refers to the lowest unoccupied molecular orbital within molecular orbital theory, and represents the upper boundary of the HOMO-LUMO gap.

The term “DMF”, as used herein, refers to N,N-dimethylformamide.

### List Of Embodiments

The following is a list of non-limiting embodiments.
1. A functionalized single-walled carbon nanotube, said nanotube comprising at least one divalent functional group of Formula I:

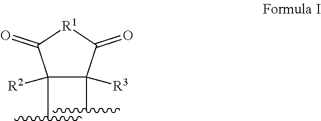

wherein
R¹ is chosen from —O—, —NR⁴, and —CR⁵R⁶;
R² and R³ are independently chosen from H and —C₁₋₄ alkyl;
R⁴ is H or —C₁₋₄ alkyl;
R⁵ is H or C₁₋₆ alkyl;
R⁶ is H or C₁₋₆ alkyl; and
wherein said at least one divalent functional group is covalently bonded to a sidewall of said single-walled carbon nanotube; and
wherein said nanotube emits near infrared photons at a wavelength in the range of about 900 nm to about 1700 nm.
2. The nanotube of embodiment 1, wherein said at least one divalent functional group is a compound of Formula IA:

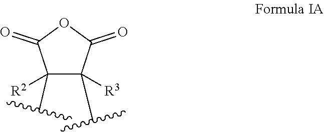

wherein R¹ is —O—.
3. The nanotube of embodiment 1, wherein said at least one divalent functional group is a compound of Formula IB:

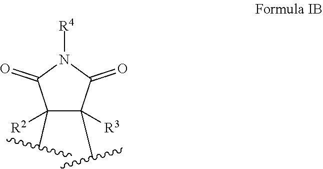

wherein R¹ is —NR⁴; and
wherein R⁴ is C₁₋₄ alkyl.
4. The nanotube of embodiment 3, wherein said at least one divalent functional group is a compound of Formula IB′:

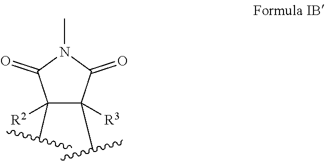

wherein R⁴ is methyl.
5. The nanotube of embodiment 1, wherein said at least one divalent functional group of Formula I is a compound of Formula IC:

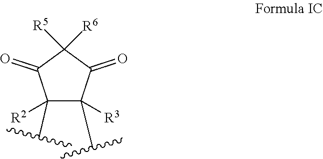

wherein R¹ is CR⁵R⁶; and
R⁵ and R⁶ are independently chosen from H and C₁₋₄ alkyl.
6. The nanotube of embodiment 5, wherein said at least one divalent functional group of Formula I is a compound of Formula IC′:

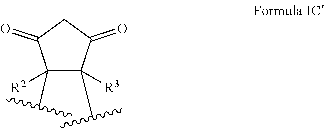

wherein R⁵ and R⁶ are H.
7. The nanotube according to embodiment 1, wherein said functionalized group is of the Formula II:

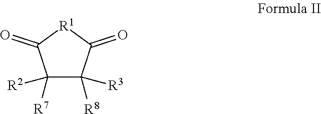

wherein R¹ is chosen from —O—, —NR⁴, or —CR⁵R⁶;
R² and R³ are independently chosen from H and —C₁₋₄ alkyl;
R⁴ is H or —C₁₋₄ alkyl;
R⁵ is H or C₁₋₆ alkyl;
R⁶ is H or C₁₋₆ alkyl; and
R⁷ and R⁸ are adjacent carbons on said sidewall.
8. The nanotube of embodiment 1, wherein R¹ is —O—, R² is —C₁₋₄ alkyl, and R³ is —C₁₋₄ alkyl.
9. The nanotube of embodiment 1, wherein R¹ is —O—, R² is H, and R³ is H.
10. The nanotube of embodiment 1, wherein R¹ is —NR₄, R² is H, R³ is H, and R⁴ is H or —C₁₋₄ alkyl.
11. The nanotube of embodiment 1, wherein R¹ is —NR₄, R² is H, R³ is H, and R⁴ is methyl.
12. The nanotube of embodiment 1, wherein R¹ is —CR₅R⁶, R² is —C₁₄ alkyl, R³ is —C₁₋₄ alkyl, R⁵ is H, and R⁶ is H.
13. The nanotube of embodiment 1, wherein R¹ is —CR⁵R⁶, R² is H, R³ is H, R⁵ is H, and R⁶ is H.
14. The nanotube of embodiment 1, wherein said nanotube is a (6,5), (6,4), (7,5), (7,6), (8,4), (10,0), (11,0), (9,1), (12,1), (9,2), or (10,5)-single-walled carbon nanotube.
15. A functionalized single-walled carbon nanotube, wherein said nanotube is made by a process comprising the steps of:
   a. combining single-walled carbon nanotubes with a solvent having a boiling point higher than 110° C. to form a suspension;
   b. adding one or more compounds of Formula IIIB to said suspension to form a mixture comprising a liquid component and a solid component;
   c. increasing the temperature of said mixture to the range of about 70° C. to about 90° C. for a period of time; and
   d. after said period of time, filtering said mixture to obtain the solid components;

wherein said nanotube emits photons at a wavelength of about 1130 nm.
16. The composition of embodiment 19, wherein said one or more compounds of Formula IIIB and said nanotubes are covalently bound through a 4-member ring forming [2+2] cycloaddition.
17. A functionalized single-walled carbon nanotube, wherein said nanotube is made by a process comprising the steps of:
   a. combining single-walled carbon nanotubes with a solvent having a boiling point higher than 110° C. to form a suspension;
   b. adding one or compounds of Formula IIIB to said suspension to form a mixture comprising a liquid component and a solid component;
   c. increasing the temperature of said mixture to the range of about 90° C. to about 110° C. for a period of time; and
   d. after said period of time, filtering said mixture to obtain the solid components; wherein said composition emits photons at a wavelength of about 1111 nm and about 1128 nm.
18. The nanotube of embodiment 21, wherein said one or more compounds of Formula IIIB and said nanotubes are covalently bound via a 4-member ring forming [2+2] cycloaddition chemical reaction.
19. A functionalized single-walled carbon nanotube, wherein said composition emits photons at a wavelength of about 1111 nm; and wherein said nanotube is made by a process comprising the steps of:
   a. combining single-walled carbon nanotubes with a solvent having a boiling point higher than 110° C. to form a suspension;
   b. adding one or compounds of Formula IIIB to said suspension to form a mixture comprising a liquid component and a solid component;
   c. increasing the temperature of said mixture to the range of about 110° C. to about 140°° C. for a period of time; and
   d. after said period of time, filtering said mixture to obtain the solid components.
20. The nanotube of embodiment 23, wherein said one or more compounds of Formula IIIB and said nanotubes are covalently bound via a 4-member ring forming [2+2] cycloaddition chemical conversion.
21. A functionalized single-walled carbon nanotube, wherein said composition emits photons at a wavelength between 900 nm and 1700 nm; and wherein said nanotube is made by a process comprising the steps of:
   a. combining single-walled carbon nanotubes with a solvent having a boiling point higher than 110° C. to form a suspension;
   b. adding one or compounds of Formula IIIB to said suspension to form a mixture comprising a liquid component and a solid component;
   c. increasing the temperature of said mixture to the range of about 90° C. to about 140° C. for a period of time; and
   d. after said period of time, filtering said mixture to obtain the solid components.
22. The nanotube of embodiment 25, wherein said one or more compounds of Formula IIIB and said nanotubes are covalently bound via a 4-member ring forming [2+2] cycloaddition chemical conversion.
23. The nanotube of any of the preceding embodiments, wherein said at least one divalent functional group is covalently bonded to a sidewall of said nanotube at an angle relative to an axis of the nanotube;
   wherein said angle is in the range of about 0° to about 90° relative to the axis of the nanotube.
24. The nanotube of any of the preceding embodiments, wherein said angle is about 0°, or about 15°, or about 30°, or about 75°, or about 87°.
25. The nanotube of any of the preceding embodiments, wherein said nanotube emits photons at a frequency in the range of about 1100 nm to about 1600 nm.
26. The nanotube of embodiment 25, wherein said nanotube emits photons at a wavelength of about 1100 to about 1300 nm, or about 1111 nm, about 1130 nm, or about 1250 nm, or about 1550 nm.
27. The nanotube of any of the preceding embodiments, wherein said nanotube has three (3) bonding configurations.
28. The nanotube of embodiment 1, wherein said nanotube is of Formula IIIA′, IIIB′ or IIIC′ has a dominant single bonding configuration capable of emitting single photons at about 1112, about 1139 or about 1213 nm wavelength.
29. A quantum emitter composition, said composition comprising a nanotube of any of preceding embodiments.
30. The composition of embodiment 27, wherein said composition is monodispersed.
31. A method of making a functionalized single-walled carbon nanotube, said method comprising:
   a. combining single-walled carbon nanotubes with a solvent having a boiling point higher than 110° C. to form a suspension;
   b. adding a compound of Formula III to said suspension to form a mixture comprising a liquid component and a solid component;

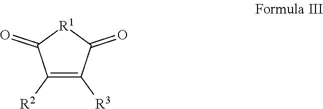

wherein R¹ is chosen from —O—, —NR⁴, and —CR⁵R⁶;
R² and R³ are independently chosen from H and —C₁₋₄ alkyl;
R⁴ is H or —C₁₋₄ alkyl;
R⁵ is H or —C₁₋₆ alkyl; and
R⁶ is H or —C₁₋₆ alkyl;
c. increasing the temperature of said mixture for a period of time; and
d. after said period of time, separating said solid components from said liquid components.
32. The method of embodiment 31, wherein said compound is a compound of Formula IIIA:

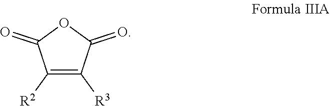

33. The method of embodiment 31, wherein said compound is a compound of Formula IIIB:

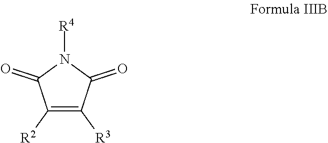

wherein R¹ is —NR⁴ ; and
wherein R⁴ is C₁₋₄ alkyl.
34. The method of embodiment 33, wherein said compound is a compound of Formula IIIB′:

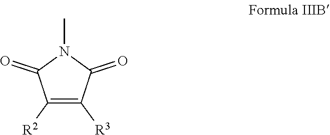

wherein R⁴ is methyl.
35. The method of embodiment 31, wherein said compound is a compound of Formula IIIC:

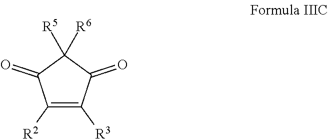

wherein R¹ is CR⁵R⁶; and
R⁵ and R⁶ are independently chosen from H and C₁₋₄ alkyl.
36. The method of embodiment 35, wherein said one or more compounds of Formula III is a compound of Formula IIIC′:

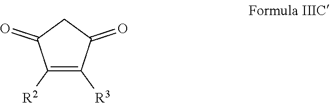

wherein R⁵ and R⁶ are H.
37. The method of embodiment 31, wherein said solvent is polar.
38. The method of embodiment 31, wherein said solvent is chosen from ethylene glycol and DMF.
39. The method of embodiment 31, wherein increasing the temperature of said mixture comprises heating said mixture to a temperature in the range of about 70° C. to about 200° C., or in the range of about 70° C. to 90° C., or in the range of about 90° C. to about 110° C., or in the range of about 110° C. to about 140° C.
40. The method of embodiment 31, wherein said period of time is in the range of about 1 hour to about 24 hours.
41. The method of embodiment 31, wherein said period of time is in the range of about 12 hours to about 20 hours, or in the range of about 6 to about 12 hours, or is about 2 hours.
42. The method of embodiment 31, further comprising the additional steps of:
   a. washing said solid components a first instance with a first solvent;
   b. washing said solid components a second instance with a second solvent; and
   c. drying said solid components.
43. The method of embodiment 42, wherein said first solvent is water or an alcohol (e.g., methanol, ethanol, or isopropanol).
44. The method of embodiment 42, wherein said second solvent is an alcohol (e.g., methanol, ethanol, or isopropanol).
45. The method of embodiment 42, wherein drying said solid components comprises drying under a vacuum.

### EXAMPLES

The following examples are provided solely to illustrate the present invention and are not intended to limit the scope of the invention, described herein. All publications mentioned herein are incorporated by reference to the extent they support the present invention.

### Example 1. Synthesis and Characterization of Monodispersed Quantum Emitters

To synthesize the divalent OCCs via [2+2] cycloaddition, CoMoCat SG65i SWCNTs is used, which primarily consist of the (6,5) nanotube chirality, along with minor (8,3) and (7,5) components and a limited amount of larger diameter nanotubes, such as (7,6) and (8,4). FIG. 2a shows a PL excitation-emission two-dimensional (2D) map of the SG65i starting material, in which the E11 emissions of the different chiralities can be identified. To conduct the [2+2] cycloaddition reaction, 1-5 mg of this SWCNT powder was added to ethylene glycol, which is a highly viscous “solvent” that can kinetically suspend the SWCNTs by the shearing force created from a stir bar, in which the resulting suspension remains stable for ˜2 days. 2-15 mg of the enophile molecules, such as N-MMI, MA, or CPD, is added to this SWCNT suspension under stirring, and then heated the mixture overnight at different temperatures, ranging from 70° C. to 140° C., to activate the reaction. The resulting OCC-functionalized SWCNTs (OCC-SWCNTs) were then subsequently dispersed in 1 wt/v % sodium deoxycholate (DOC)/D2O solution for further characterization (see Methods for details).

After the reaction, the 2D excitation-emission map of the samples is measured to determine whether OCCs were successfully added to the nanotubes. FIG. 2b shows the ensemble PL results of the N-MMI functionalized SWCNTs (N-MMI-SWCNTs) at 100° C. Compared to the pristine starting material, the functionalized SWCNTs show multiple OCC emissions redshifted from the E₁₁ peaks of the individual chiralities, convoluted at >1100 nm. In contrast, when the same reaction was conducted at 100° C. but without the addition of N-MMI, the same E₁₁ SWCNT emission (FIG. 2c) was observed as the pristine nanotubes (FIG. 2a). The PL emission spectra of the pristine SWCNTs, N-MMI-SWCNTs, and SWCNTs without the addition of N-MMI are shown in FIG. 2d using 565 nm excitation, which is the E₂₂ band of (6,5)-SWCNTs. There is a bright OCC emission peak at ˜1130 nm (1.097 eV) with a shoulder band extending to 1400 nm (0.886 eV) for the SWCNTs reacted with N-MMI at 100° C. In contrast, the control group (no N-MMI added) shows no significant increase in PL intensity in the range of >1100 nm, though its E₁₁ emission shows a marginal blueshift of ˜1-2 nm compared to the pristine nanotubes. Also measured were the 2D PL maps and emission spectra (565 nm excitation) for SWCNTs reacted with MA and CPD at 100° C. (FIG. S1). Similar to N-MMI, new OCC-induced emission was observed for both samples in the range of 1100-1300 nm.

The Raman spectra of the reacted samples were measured to further confirm the covalent functionalization of the SWCNTs rather than surface adsorption. The Raman G-band (˜1580 cm⁻¹) is related to the stretching of the sp² C-C bonds in graphitic material. Upon covalent functionalization, the conversion of the sp² hybridized carbon atoms into sp3 results in the increase of the Raman D-band (˜1316 cm⁻¹). FIG. 2e shows the Raman spectra of the pristine SWCNTs and N-MMI-SWCNTs. After the reaction, the D/G ratio increased from 0.07 to 0.31. These results show the OCCs are covalently functionalized on the SWCNTs, which generates the optically allowed OCC PL emission in the observed redshifted range.

To further investigate the convoluted emission of the N-MMI-SWCNTs prepared at 100° C. (1100-1300 nm, FIG. 2b), hyperspectral PL microscopy was used to directly observed the PL of individual nanotubes. This method allows us to circumvent averaging effects in the ensemble PL to observe what individual emission may be occurring. To prepare the sample, the nanotubes were dispersed in 1 wt % DOC aqueous solution, which was deposited on a polystyrene (PS)-coated Au on Si substrate (see Methods). Note, ultrasonication was used during the dispersion step, which cuts the SWCNTs short, beyond the diffraction limit. Therefore, the individual nanotube PL appears as white spots rather than rod-like, as shown in FIG. 3a. In addition to the use of tip sonication and centrifugation to individualize and remove nanotube bundles, the sample was diluted 1000-fold prior to deposition to ensure the SWCNTs were well-separated and individualized.

Unlike the ensemble PL, which featured convoluted OCC emission, the hyperspectral imaging revealed 32 individual N-MMI-SWCNTs that featured three distinct OCC peaks at ˜1112 nm (1.115±0.008 eV; FIG. 3c), ˜1139 nm (1.089±0.006 eV; FIGS. 3d), and ˜1213 nm (1.022±0.012 eV; FIG. 3e). These peaks are denoted as E₁₁_{^{−a}}, E₁₁_{^{−b}}, and E₁₁^{-c}, respectively (Table 1), all of which feature a similar full-width at half maximum (FWHM) of 0.032±0.008 eV, 0.033±0.007 eV, and 0.038±0.010 eV. While some nanotubes displayed only one of these peaks, convoluted, multi-peak OCC emission was observed from individual nanotubes (FIG. S2). A statistical analysis of the numbers of OCCs peaks is shown in FIG. 3b. Similar OCC emission was observed for (8,3) and (7,5)-SWCNTs functionalized by the same cycloaddition reaction using N-MMI (FIG. S3). These results suggest the three observed OCC emission peaks may be related to the three possible bonding configurations of the [2+2] cycloaddition product, which is significantly reduced compared to the six distinct emission peaks of the six bonding configurations created by monovalent diazonium chemistry. Additionally, it is hypothesized that more than one OCC of different bonding configuration can be present on the same SWCNT, which would explain the multi-peak emission observed from some of the individual nanotubes.

TABLE 1
PL peak energy and spectral shift (ΔE) of the N-MMI-(6,5)-
SWCNTs based on individual nanotube and ensemble measurements.

| | | | Ensemble | |
|---|---|---|---|---|
| | Individual | ΔE (eV)* of | nanotube | ΔE (eV)* of |
| | nanotube PL (eV) | individual PL | PL (eV) | ensemble PL |
| E₁₁^{-a} | 1.115 ± 0.008 | 0.135 ± 0.007 | 1.121 | 0.132 |
| E₁₁^{-b} | 1.089 ± 0.006 | 0.162 ± 0.010 | 1.102 | 0.151 |
| E₁₁^{-c} | 1.022 ± 0.012 | 0.228 ± 0.010 | 1.002 | 0.248 |

*ΔE = E_{OCC emission} − E₁₁.

To further explore these 3 different OCC emission peaks, an objective was made to thermodynamically control the reaction products using temperature. First, SWCNTs were functionalized at different temperatures ranging from 80-120° C. at a [N-MMI]: [C] ratio of 7:1 and measured the ensemble PL spectra (FIG. 4) as well as the 2D PL maps (FIG. S4). Note, the OCC emissions were deconvoluted in the ensemble PL spectra of these samples based on the relative energy difference between the E₁₁ and E_{OCC emission} peaks (ΔE), as determined from the hyperspectral imaging results (see Table 1 and the Methods for details). At the reaction temperature of 80° C., the resulting OCC emission primarily features E₁₁_{^{−b}} at ˜1130 nm (˜1.097 eV) (FIG. 4, S4a). As the temperature is increased beyond 90° C., E₁₁_{^{−c and E}}₁₁_{^{−a}} begin to dominate the spectra. Specifically, at 120° C., the OCC emission switches to E₁₁_{^{−a}} at ˜1111 nm (˜1116 eV) along with E₁₁_{^{−c}} at ˜1228 nm (1.010 eV) (FIG. 4, S4d). Similarly, the temperature-dependence of OCC implantation was investigated using MA ([MA]: [C]=20:1) at reaction temperatures of 70° C. to 140° C. (FIG. S5). The lower reaction temperature (70-90° C.) favors E₁₁_{^{−b}}, while higher temperature (110-140° C.) favors the formation of E₁₁_{^{−a}}. E₁₁_{^{−c}} is also synthesized at a medium temperature in this range, such as 90-110° C. However, at a higher temperature of 140° C., E₁₁_{^{−c}} is less favorable and the main emission is E₁₁_{^{−}}. These results suggest the formation of E₁₁_{^{−b}} is kinetically favored with a smaller activation energy, while the formation of E₁₁_{^{−a}} and Ent requires higher activation energy (FIG. S6). However, E₁₁_{^{−a}} is more favorably synthesized at higher temperature compared to E₁₁_{^{−c}}, therefore the E₁₁_{^{−a}} emission likely derives from the most thermodynamically stable OCC product compared to E₁₁_{^{−b}} and E₁₁_{^{−6}}.

To better understand the three OCC emissions, DFT and time-dependent DFT (TD-DFT) were utilized to calculate the optical properties of the N-MMI-(6,5)-SWCNTs. Three bonding configurations of 10-nm-long (6,5)-SWCNTs were installed with N-MMI OCCs via the [2+2] cycloaddition mechanism at different pairing positions of PP (−⅔, ⅓), PP (⅓, ⅓), and PP (⅓, −⅔), as shown in FIG. 5a-c (Note: this notation of bonding configuration is described in a previous study). Based on the geometry optimization, the total energies of each isomer (proportional to each isomer's Gibbs free energy) were obtained, which are listed in Table 2. Among the isomers, PP (−⅔, ⅓) had the lowest total energy. Thus, the relative total energy based on this most thermodynamically stable isomer is calculated. The total energies of the PP (⅓, ⅓) and PP (⅓, −⅔) isomers were 0.100 eV and 0.069 eV higher than that of PP (−⅔, ⅓), respectively, suggesting they may be kinetic products.

TABLE 2
Total energy and relative total energy of
each bonding configuration obtained by DFT.

| Configuration | Total energy (Hartree) | Relative total energy (eV) |
|---|---|---|
| PP(⅓, ⅓) | −34292.69095 | 0.10032 |
| PP(⅓, −2/3) | −34292.69212 | 0.06851 |
| PP( −2/3, ⅓) | −34292.69463 | 0 |
| pristine (6, 5)- | −34292.71638 | −0.59141 |
| SWCNT + | | |
| N-MMI | | |

The excited states of these isomers were simulated via TD-DFT to obtain the OCC PL wavelengths of each isomer. FIG. 5d and Table 3 show that PP (−⅔, ⅓), PP (⅓, ⅓), and PP (⅓, −⅔) have simulated OCC emissions at 960 nm, 972 nm, and 1186 nm, respectively. Note that the wavelengths found by TD-DFT are blue-shifted than what would be observed experimentally due to limitation of the DFT methodology (quantum confinement effects due to vacuum environment and the short tube length used in the model, the limited basis set used, etc.). Since, these factors affect the emission signal for all defect bonding configurations similarly and do not change the relative energy order between the different bonding configurations, the relative positions of the 3 peaks allow for a reasonable assignment of the experimental peaks. As shown in

FIG. 5d, comparing the simulated peaks to the experimental data shown in FIGS. 4 and S5-6 allows us to assign the thermodynamic bonding configuration PP (−⅔, ⅓) to the E₁₁_{^{−a}} peak at 1112 nm, while the kinetic configurations of PP (⅓, ⅓) and PP (⅓, −⅔) can be assigned to E₁₁_{^{−b}} at 1139 nm and E₁₁_{^{−c}} at 1213 nm, respectively. These results consistently suggest the [2+2] cycloaddition chemistry limits the number of bonding configurations.

TABLE 3
OCC emission energy of each bonding
configuration obtained by TD-DFT.

| Configuration | Wavelength (nm) | Oscillator strength (a.u.) |
|---|---|---|
| PP(⅓, ⅓) | 972.60 | 6.75 × 10⁷ |
| PP(⅓, −2/3) | 1186.06 | 8.18 × 10⁷ |
| PP( −2/3, ⅓) | 960.58 | 5.04 × 10⁷ |

### Example 2. Synthesis of OCCs through [2+2] Cycloaddition

The OCCs were synthesized using a [2+2] cycloaddition reaction based on the addition of various enophiles to the conjugated double-bond SWCNT structure. For a typical reaction, ˜1-5 mg of SWCNT powder (CoMoCat SG65i, Sigma Aldrich, Lot #MKBZ1159V) was added to ˜5 mL of ethylene glycol (VWR, lot 000238286) in a 10 mL round bottom flask. Then ˜2-15 mg of enophile (EP), including N-MMI (Sigma Aldrich, 97%), MA (Sigma Aldrich, 99%), or CPD (Sigma Aldrich, 95%), was added to the mixture of SWCNTs and ethylene glycol. Different weights of N-MMI, MA, or CPD were used with the mole ratio of [EP]:[C] in the range of 20:1-7:1. [C] was calculated based on the total mass of the SWCNT powder without considering the (6,5)-SWCNT purity. The round bottom flask was placed in a mineral oil bath and heated overnight at a temperature of 70-140° C. The reaction was stopped by cooling down to room temperature and filtering out the SWCNTs on a polyvinylidene fluoride membrane (MilliporeSigma VVLP membrane, 0.1 μm pore size), and then rinsed with ˜50 mL of Nanopure™ water at least three times. Then 5 mL of ethanol was used to rinse the SWCNTs at least three times to remove the water. The powder was dried under vacuum at room temperature for 1 h to obtain a dry powder of OCC functionalized SWCNTs (OCC-SWCNTs).

### Example 3. Individual Dispersion of OCC-SWCNTs

The dry OCC-SWCNTs powder was dispersed by ultrasonication (Misonix) in 1 wt % DOC (Sigma Aldrich)-H₂O solution at 4 W/mL for 30 min. Typically, ˜1 mg of OCC-SWCNTs was dispersed by 1.5-2 mL 1 wt % DOC solution, followed by centrifugation at 25000 g (1717 rad/s, 16400 rpm on Eppendorf centrifuge 5417 R) for 1 h to remove bundled SWCNTs.

### Example 4. PL Characterization and Raman Spectroscopy

The ensemble PL spectra were collected using a NanoLog spectrofluorometer (Horiba Jobin Yvon). The samples were excited with a 450 W Xenon source dispersed by a double-grating monochromator. The slit width bandpass of the excitation and emission beams were both set to 10 nm. The PL spectra were collected using a liquid-N₂ cooled linear InGaAs array detector. The emission spectra were collected with excitation light at the E₂₂ wavelength of each specific chirality. The integration time for the PL spectra and PL excitation map were 2-60 s and 5 s, respectively. Note that all samples were diluted with 1 wt % DOC and had an optical density at the

En band of less than 0.5 (A/cm), measured using a PerkinElmer Lambda 1050 spectrophotometer with a broadband InGaAs detector.

PL images of the OCC-SWCNTs were imaged on the single nanotube level using a hyperspectral imaging setup. In brief, ˜5 μL of the 1000-fold diluted OCC-SWCNTs solution was drop-cast on a polystyrene-coated Au-on-Si substrate. The polystyrene layer insulates the SWCNTs from contacting with the Au, which would quench the PL, while the Au layer is used as a mirror to enhance the efficiency of excitation and collection of the emission. An infrared optimized 100x objective (LCPLN100XIR, numerical aperture (NA)=0.85, Olympus) was used, along with a continuous wave laser at 730 nm (Shanghai Dream Lasers Technology Co., Ltd.) as the excitation light source. Fluorescent emission from the sample was filtered through a long pass dichroic mirror (875 nm edge, Semrock, USA), which removed the elastic laser scattering from the sample, then dispersed by a volume Bragg grating (VBG; Photon Etc, Inc. Montreal, Canada). Only the diffracted light with a narrow bandwidth of 3.7 nm was collected on the detector to form a spectral image.

As the functionalized SWCNT samples were prepared in ethylene glycol and sonicated under aqueous conditions, there is some peak position variation that can be attributed to different degrees of water or ethylene glycol filling inside the nanotubes. Therefore, a more accurate way to compare the relative energy of each bonding configuration is through the relative energy difference between the E₁₁ peak and the OCC emission (ΔE=ΔE=E_{OCC emission}−E₁₁; Table 1), which corresponds to the OCC trapping depth. Therefore in FIG. 4, the OCC emission peaks are deconvoluted based on ΔE rather than solely using the emission energies themselves.

Raman spectroscopy was performed using a LabRAM ARAMIS Raman microscope (Horiba Jobin Yvon), 532 nm laser excitation (46 mW), and a 1.0 neutral density filter to prevent sample damage. The integration time was 1 s, taken 10 times in total. The dispersed nanotube solution was precipitated with ethanol and then deposited on a Si substrate, which simultaneously served as a reference with the Si peak at 520.7 cm⁻¹ during the measurement.

### Example 5. Density Functional Theory (DFT)

All DFT calculations were performed with Gaussian 09 software. A 10 nm (6,5)-SWCNT was functionalized with N-MMI at 3 ortho positions (PP (⅓, ⅓), PP (⅓, −⅔), and PP (-2/3,1/3)), as shown in FIG. 5. The geometries of all structures were optimized using the Coulomb-attenuated B3LYP (CAM-B3LYP) functional and 3-21G basis set. The optical transitions were computed using TD-DFT with the same functional and basis set as in DFT. The natural transition orbitals (NTOs) have been analyzed with Gaussian 09 software and confirmed the NTOs were strongly localized at the OCC, further verifying the defect origin of the optical transitions (FIG. S7). The simulated peaks are noted to higher in energy compared to the experimental data mainly due to the vacuum environment used in the simulation, the finite length of the SWCNTs, and the limited basis set. However, these limitations do not change the relative emission energy ordering of the different bonding configurations and hence there was no attempt to make correction of the simulated peaks to the experimentally observed range as the correction is a qualitative adjustment and requires significantly more computational expense.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
[1] Y. Piao, B. Meany, L. R. Powell, N. Valley, H. Kwon, G. C. Schatz and Y. Wang, Nat. Chem., 2013, 5, 840-845.
[2] T. Shiraki, Y. Miyauchi, K. Matsuda and N. Nakashima, Acc. Chem. Res., 2020, 53, 1846-1859.
[3] A. H. Brozena, M. Kim, L. R. Powell and Y. Wang, Nat. Rev. Chem., 2019, 3, 375-392.
[4] M. E. Sykes, M. Kim, X. Wu, G. P. Wiederrecht, L. Peng, Y. Wang, D. J. Gosztola and X. Ma, ACS Nano, 2019, 13, 13264-13270.
[5] A. H. Brozena, J. D. Leeds, Y. Zhang, J. T. Fourkas and Y. Wang, ACS Nano, 2014, 8, 4239-4247.
[6] H. Kwon, M. Kim, M. Nutz, N. F. Hartmann, V. Perrin, B. Meany, M. S. Hofmann, C. W. Clark, H. Htoon, S. K. Doorn, A. Hogele and Y. Wang, ACS Cent. Sci., 2019, 5, 1786-1794.
[7] X. He, N. F. Hartmann, X. Ma, Y. Kim, R. Ihly, J. L. Blackburn, W. Gao, J. Kono, Y. Yomogida, A. Hirano, T. Tanaka, H. Kataura, H. Htoon and S. K. Doorn, Nat. Photonics, 2017, 11, 577-582.
[8] H. B. Luo, P. Wang, X. Wu, H. Qu, X. Ren and Y. Wang, ACS Nano, 2019, 13, 8417-8424.
[9] L. R. Powell, M. Kim and Y. Wang, J. Am. Chem. Soc., 2017, 139, 12533-12540.
[10]H. Kwon, A. Furmanchuk, M. Kim, B. Meany, Y. Guo, G. C. Schatz and Y. Wang, J. Am. Chem. Soc., 2016, 138, 6878-6885.
[11]X. Wu, M. Kim, H. Kwon and Y. Wang, Angew. Chem. Int. Ed. Engl., 2018, 57, 648-653.
[12]D. Kozawa, X. Wu, A. Ishii, J. Fortner, K. Otsuka, R. Xiang, T. Inoue, S. Maruyama, Y. Wang and Y. K. Kato, Nat. Commun., 2022, 13, 2814.
[13]A. Saha, B. J. Gifford, X. He, G. Ao, M. Zheng, H. Kataura, H. Htoon, S. Kilina, S. Tretiak and S. K. Doorn, Nat. Chem., 2018, 10, 1089-1095.
[14]H. Qu, X. Wu, J. Fortner, M. Kim, P. Wang and Y. Wang, ACS Nano, 2022, 16, 2077-2087.
[15]G. Schmidt, S. Gallon, S. Esnouf, J. P. Bourgoin and P. Chenevier, Chem. Eur. J., 2009, 15, 2101-2110.
[16]H. Kwon, M. Kim, B. Meany, Y. Piao, L. R. Powell and Y. Wang, J. Phys. Chem. C, 2015, 119, 3733-3739.
[17]T. Shiraki, H. Onitsuka, T. Shiraishi and N. Nakashima, Chem. Commun. (Camb), 2016, 52, 12972-12975.
[18]F. A. Mann, N. Herrmann, F. Opazo and S. Kruss, Angew. Chem. Int. Ed., 2020, 59, 17732-17738.
[19]G. Hong, S. Diao, A. L. Antaris and H. Dai, Chem. Rev., 2015, 115, 10816-10906.
[20]C. T. Jackson, S. Jeong, G. F. Dorlhiac and M. P. Landry, iScience, 2021, 24, 102156.
[21]A. K. Mandal, X. Wu, J. S. Ferreira, M. Kim, L. R. Powell, H. Kwon, L. Groc, Y. Wang and L. Cognet, Sci. Rep., 2020, 10, 5286.
[22]M. Kim, C. Chen, P. Wang, J. J. Mulvey, Y. Yang, C. Wun, M. Antman-Passig, H.-B. Luo, S. Cho, K. Long-Roche, L. V. Ramanathan, A. Jagota, M. Zheng, Y. Wang and D. A. Heller, Nature Biomedical Engineering, 2022, 6, 267-275.
[23]D. Tobia, R. Harrison, B. Phillips, T. L. White, M. DiMare and B. Rickborn, The Journal of Organic Chemistry, 1993, 58, 6701-6706.
[24]R. Hoffmann and R. B. Woodward, Science, 1970, 167, 825-831.
[25]R. B. Woodward and R. Hoffmann, J. Am. Chem. Soc., 2002, 87, 395-397.
[26]I. Kumar, S. Rana and J. W. Cho, Chemistry, 2011, 17, 11092-11101.
[27]X. He, I. Kevlishvili, K. Murcek, P. Liu and A. Star, ACS Nano, 2021, 15, 4833-4844.
[28]M. S. Dresselhaus, G. Dresselhaus, R. Saito and A. Jorio, Phys. Rep., 2005, 409, 47-99.
[29]X. Wu, M. Kim, H. Qu and Y. Wang, Nat. Commun., 2019, 10, 2672.
[30]Y. Li, X. Wu, M. Kim, J. Fortner, H. Qu and Y. Wang, Chem. Mater., 2019, 31, 4536-4544.
[31]B. J. Gifford, S. Kilina, H. Htoon, S. K. Doorn and S. Tretiak, Acc. Chem. Res., 2020, 53, 1791-1801.
[32]X. He, L. Sun, B. J. Gifford, S. Tretiak, A. Piryatinski, X. Li, H. Htoon and S. K. Doorn, Nanoscale, 2019, 11, 9125-9132.
[33]B. J. Gifford, S. Kilina, H. Htoon, S. K. Doorn and S. Tretiak, J. Phys. Chem. C, 2018, 122, 1828-1838.
[34]B. J. Gifford, A. E. Sifain, H. Htoon, S. K. Doorn, S. Kilina and S. Tretiak, J. Phys. Chem. Lett., 2018, 9, 2460-2468.
[35]X. Ma, N. F. Hartmann, J. K. Baldwin, S. K. Doorn and H. Htoon, Nat. Nanotechnol., 2015, 10, 671-675.
[36]H. Qu, A. Rayabharam, X. Wu, P. Wang, Y. Li, J. Fagan, N. R. Aluru and Y. Wang, Nat. Commun., 2021, 12, 310.
[37]M. J. Frisch, G. W. Trucks, H. B. Schlegel, G. E. Scuseria, M. A. Robb, J. R. Cheeseman, G. Scalmani, V. Barone, G. A. Petersson, H. Nakatsuji, X. Li, M. Caricato, A. V. Marenich, J. Bloino, B. G. Janesko, R. Gomperts, B. Mennucci, H. P. Hratchian, J. V. Ortiz, A. F. Izmaylov, J. L. Sonnenberg, Williams, F. Ding, F. Lipparini, F. Egidi, J. Goings, B. Peng, A. Petrone, T. Henderson, D. Ranasinghe, V. G. Zakrzewski, J. Gao, N. Rega, G. Zheng, W. Liang, M. Hada, M. Ehara, K. Toyota, R. Fukuda, J. Hasegawa, M. Ishida, T. Nakajima, Y. Honda, O. Kitao, H. Nakai, T. Vreven, K. Throssell, J. A. Montgomery Jr., J. E. Peralta, F. Ogliaro, M. J. Bearpark, J. J. Heyd, E. N. Brothers, K. N. Kudin, V. N. Staroverov, T. A. Keith, R. Kobayashi, J. Normand, K. Raghavachari, A. P. Rendell, J. C. Burant, S. S. Iyengar, J. Tomasi, M. Cossi, J. M. Millam, M. Klene, C. Adamo, R. Cammi, J. W. Ochterski, R. L. Martin, K. Morokuma, O. Farkas, J. B. Foresman and D. J. Fox, Gaussian 09, Gaussian, Inc., Wallingford, CT, 2009.
[38]T. Yanai. D. P. Tew and N. C. Handy, Chem. Phys. Lett., 2004. 393. 51-57.
[39]J. S. Binkley. J. A. Pople and W. J. Hchre, J. Am. Chem. Soc., 2002. 102. 939-947.
[40]Wang et al., U.S. Pat. No. 9,983,058 B2
[41]Wang et al., U.S. Patent No. 10,414 974 B1

We claim:

1. A functionalized single-walled carbon nanotube, said nanotube comprising at least one divalent functional group of Formula I: 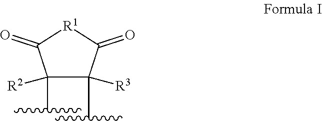
wherein
R¹ is chosen from —O—, —NR₄, and —CR₅R₆;
R² and R³ are independently chosen from H and —C₁₋₄ alkyl;
R⁴ is H or —C₁₋₄ alkyl;
R⁵ is H or C₁₋₆ alkyl;
R⁶ is H or C₁₋₆ alkyl; and
wherein said at least one divalent functional group is covalently bonded to a sidewall of said single-walled carbon nanotube; and
wherein said nanotube emits near infrared photons at a wavelength in the range of about 900 nm to about 1700 nm.

2. The nanotube of claim 1, wherein said at least one divalent functional group is a compound of Formula IA: 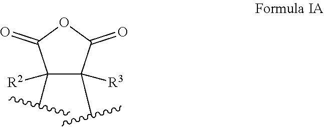
wherein R¹ is —O—.

3. The nanotube of claim 1, wherein said at least one divalent functional group is a compound of Formula BB: 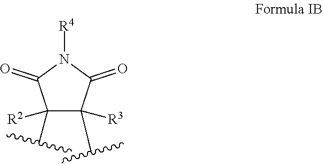
wherein R¹ is —NR⁴; and
wherein R⁴ is C₁₋₄ alkyl.

4. The nanotube of claim 3, wherein said at least one divalent functional group is a compound of Formula IB′: 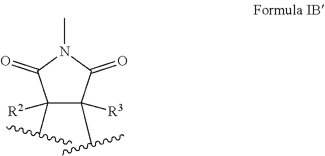
wherein R⁴ is methyl.

5. The nanotube of claim 1, wherein said at least one divalent functional group of Formula I is a compound of Formula IC: 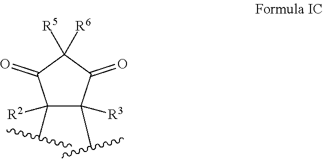
wherein R¹ is CR⁵R⁶; and
R⁵ and R⁶ are independently chosen from H and C₁₋₄ alkyl.

6. The nanotube of claim 5, wherein said at least one divalent functional group of Formula I is a compound of Formula IC': 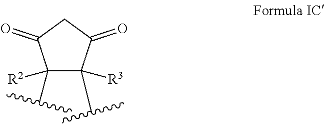
wherein R⁵ and R⁶ are H.

7. The nanotube of claim 1, wherein said nanotube is a (6,5), (6,4), (7,5), (7,6), (8,4), (10,0), (11,0), (9,1), (12,1), (9,2), or (10,5)-single-walled carbon nanotube.

8. A functionalized single-walled carbon nanotube, wherein said nanotube is made by a process comprising the steps of:
a. combining single-walled carbon nanotubes with a solvent having a boiling point higher than 110° C. to form a suspension;
b. adding one or compounds of Formula IIIB to said suspension to form a mixture comprising a liquid component and a solid component;
c. increasing the temperature of said mixture to the range of about 90° C. to about 140° C. for a period of time; and
d. filtering said mixture to obtain the solid components;
wherein said composition emits photons at a wavelength between 900 nm and 1700 nm.

9. The nanotube of claim 1, wherein said at least one divalent functional group is covalently bonded to a sidewall of said nanotube at an angle relative to an axis of the nanotube;
wherein said angle is in the range of about 0° to about 90° relative to the axis of the nanotube.

10. The nanotube of claim 15, wherein said angle is about 0°, or about 15°, or about 30°, or about 75°, or about 87°.

11. The nanotube of claim 1, wherein said nanotube emits photons at a frequency in the range of about 1100 nm to about 1600 nm.

12. The nanotube of claim 9, wherein said nanotube has three (3) bonding configurations.

13. A quantum emitter composition, said composition comprising a nanotube of claim 1.

14. The composition of claim 13, wherein said composition is monodispersed.

15. A method of making a functionalized single-walled carbon nanotube, said method comprising:
a. combining single-walled carbon nanotubes with a solvent having a boiling point higher than 110° C. to form a suspension;
b. adding a compound of Formula III to said suspension to form a mixture comprising a liquid component and a solid component; 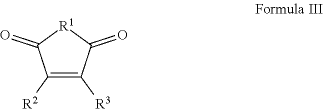
wherein R¹ is chosen from —O—, —NR⁴, and —CR⁵R⁶;
R² and R³ are independently chosen from H and —C₁₋₄ alkyl;
R⁴ is H or —C₁₋₄ alkyl;
R⁵ is H or —C₁₋₆ alkyl; and
R⁶ is H or —C₁₋₆ alkyl;
c. increasing the temperature of said mixture for a period of time; and
d. after said period of time, separating said solid components from said liquid components.

16. The method of claim 31, wherein said compound is a compound of Formula IIA:

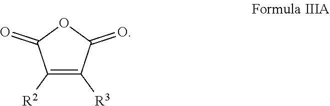

17. The method of claim 31, wherein said compound is a compound of Formula DIBB: 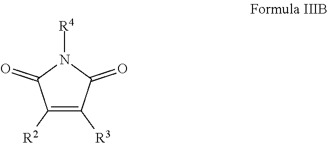
wherein R¹ is —NR₄; and
wherein R⁴ is C₁₋₄ alkyl.

18. The method of claim 33, wherein said compound is a compound of Formula IIIB′: 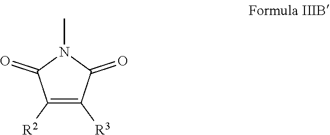
wherein R⁴ is methyl.

19. The method of claim 31, wherein said compound is a compound of Formula IIIC: 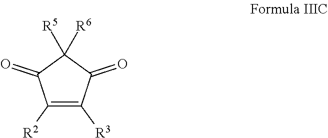
wherein R¹ is CR⁵R⁶; and
R⁵ and R⁶ are independently chosen from H and C₁₋₄ alkyl.

20. The method of claim 35, wherein said one or more compounds of Formula III is a compound of Formula IIIC′: 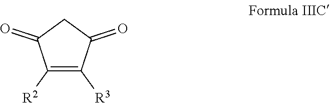
wherein R⁵ and R⁶ are H.
